(19) United States
(12) Patent Application Publication
(10) Pub. No.: US 2026/0081182 A1
(43) Pub. Date: Mar. 19, 2026

(54) BATTERY ELECTRODE WITH LAYERED STRUCTURE AND PERFORATIONS

(71) Applicant: Apple Inc., Cupertino, CA (US)

(72) Inventors: Xingxing Zhang, Sunnyvale, CA (US); Jian Hong, Cupertino, CA (US); Premanand Ramadass, San Mateo, CA (US); Wei Kah Tan, Dublin, CA (US); Wanjie Zhang, Beijing (CN); Liwen Zhou, Suzhou (CN); Chong Ling, Ma’anshan (CN); He Li, Beijing (CN); Ee Min Lim, Singapore (SG); Erik D. Gillow, Redwood City, CA (US); Mark E. Wilcox, Morgan Hill, CA (US); Rajesh Kandibanda, Menlo Park, CA (US)

(21) Appl. No.: 19/263,174

(22) Filed: Jul. 8, 2025

Related U.S. Application Data
(60) Provisional application No. 63/694,540, filed on Sep. 13, 2024.

(51) Int. Cl. H01M 4/74; H01M 4/02; H01M 4/04; H01M 4/36; H01M 4/66

(52) U.S. Cl. CPC H01M 4/742; H01M 4/0426; H01M 4/366; H01M 4/661; H01M 4/667; H01M 4/668; H01M 2004/021; H01M 2004/027; H01M 2004/028

(57) ABSTRACT

An electrode assembly includes an electrode having a laminated foil disposed between a first active material layer and a second active material layer, where the laminated foil includes a polymer substrate disposed between a first laminate layer and a second laminate layer. The electrode assembly also includes a plurality of perforations extending through the first active material layer, the second active material layer, and the laminated foil.

### CROSS-REFERENCE TO RELATED APPLICATION

This application claims priority to U.S. Provisional Application No. 63/694,540, filed Sep. 13, 2024, which is incorporated by reference herein in its entirety.

### BACKGROUND

The present disclosure relates generally to batteries, such as a secondary or rechargeable batteries (e.g., lithium-ion batteries), configured to power a load, such as an electronic device (e.g., consumer electronic device). More specifically, the present disclosure relates to an electrode assembly of the battery, including a layered structure and perforations through the layered structure.

A lithium-ion battery operates by movement of lithium cations (Li+ ions) between one or more anodes and one or more cathodes, collectively referred to as electrodes, of the lithium-ion battery. For example, movement of the Li+ ions from the anode(s) to the cathode(s) promotes a flow of electrons in a direction through a discharging circuit to power a load (e.g., during a discharging cycle). Further, a flow of electrons in an opposing direction through a charging circuit promotes a movement of the Li+ ions from the cathode(s) to the anode(s) to charge the lithium-ion battery (e.g., during a charging cycle). Electrolyte acts as a pathway or medium by which the Li+ ions move.

Unfortunately, traditional lithium-ion batteries may suffer from poor electrolyte distribution and/or Li+ ion movement, thereby reducing battery performance. Additionally or alternatively, traditional lithium-ion batteries may be susceptible to metal burring in certain componentry, which may lead to reduced battery performance, shorting, or other negative effects. Accordingly, it is now recognized that improved systems and methods are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, an electrode assembly includes an electrode having a laminated foil disposed between a first active material layer and a second active material layer, where the laminated foil includes a polymer substrate disposed between a first laminate layer and a second laminate layer. The electrode assembly also includes a plurality of perforations extending through the first active material layer, the second active material layer, and the laminated foil.

In another embodiment, a battery includes an enclosure and an electrode assembly disposed in the enclosure. The electrode assembly includes a cathode having a laminated aluminum foil disposed between a first cathode active material layer and a second cathode active material layer. A first plurality of perforations extends through the first cathode active material layer, the second cathode active material layer, and the laminated aluminum foil. The electrode assembly also includes an anode having a laminated copper foil disposed between a first anode active material layer and a second anode active material layer. A second plurality of perforations extends through the first anode active material layer, the second anode active material layer, and the laminated copper foil. The electrode assembly also includes a separator disposed between the cathode and the anode.

In another embodiment, a method includes disposing a polymer substrate between a first laminate layer and a second laminate layer to form a laminated foil of an electrode, disposing the laminated foil between a first active material layer of the electrode and a second active material layer of the electrode, and forming a plurality of perforations through the first active material layer, the second active material layer, and the laminated foil.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a block diagram of a battery configured to power a load, such as the electronic device of FIG. 1, according to embodiments of the present disclosure;

FIG. 3 is a perspective cut-away view of an electrode that may be employed in the battery of FIG. 2, including perforations through a layered structure of the electrode, according to embodiments of the present disclosure;

FIG. 4 is a top view of an electrode that may be employed in the battery of FIG. 2, including perforations through a layered structure of the electrode, according to embodiments of the present disclosure;

FIG. 5 is a cross-sectional side view of an electrode assembly that may be employed in the battery of FIG. 2, including an anode with a layered structure and perforations therethrough, a cathode with a layered structure and perforations therethrough, and a separator between the anode and the cathode, according to embodiments of the present disclosure;

FIG. 6 is a cross-sectional side view of an electrode that may be employed in the battery of FIG. 2, including a cylindrical perforation through a layered structure of the electrode, according to embodiments of the present disclosure;

FIG. 7 is a cross-sectional side view of an electrode that may be employed in the battery of FIG. 2, including a frustoconical perforation through a layered structure of the electrode, according to embodiments of the present disclosure;

FIG. 8 is a top view of an electrode that may be employed in the battery of FIG. 2, including non-uniform perforations through a layered structure of the electrode, according to embodiments of the present disclosure; and

FIG. 9 is a process flow diagram illustrating a method of manufacturing an electrode that may be employed in the battery of FIG. 2, where the electrode includes a layered structure and perforations therethrough, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1 % of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

The present disclosure relates generally to embodiments of a battery, such as a secondary or rechargeable battery (e.g., lithium-ion battery), and more specifically to a laminated foil (e.g., including a polymer substrate and metal layers on opposing sides of the polymer substrate) of an electrode, perforations through the electrode, and associated technical benefits. For example, as described in greater detail below, presently disclosed embodiments improve battery performance (e.g., by improving electrolyte distribution through the battery, movement of Li+ ions about the battery, or both) and reduce metal burring (or effects thereof) relative to traditional configurations.

In accordance with the present disclosure, a battery (e.g., a lithium-ion battery) may include, among other features, electrodes (e.g., at least one anode and at least one cathode), at least one separator, an electrolyte, and an enclosure in which the electrodes, the one separator(s), and the electrolyte are disposed. The electrodes and the separator(s) of the battery may be referred to herein as an electrode assembly. In some embodiments, the electrode assembly is wound into a jelly roll configuration, while in other embodiments, the electrode assembly is arranged in a stacked configuration or other type of configuration.

Each electrode includes a layered structure having a laminated foil (e.g., a current collector) and active material layers on opposing sides of the laminated foil. For example, the laminated foil may include a polymer substrate, a first metal layer laminated (e.g., via a sputtering technique) on a first side of the polymer substrate, and a second metal layer laminated (e.g., via a sputtering technique) on a second side of the polymer substrate opposing the first side of the polymer substrate. The first metal layer may be referred to as a first sputtered metal layer and the second metal layer may be referred to as a second sputtered metal layer in certain instances of the present disclosure. Material compositions of the polymer substrate, the metal layers (e.g., sputtered metal layers), and the active material layers may vary (e.g., a cathode may include a first set of material compositions, while an anode may include a second set of material compositions different than the first set of material compositions) and will be described in greater detail with reference to the drawings. Each electrode also includes perforations through the layered structure (e.g., through the active material layers, the metal layers, and the polymer substrate). In general, the laminated foil is configured to block, negate, or reduce metal burring (or effects thereof) that otherwise may be caused by a process that generates the perforations. The perforations are configured to improve electrolyte distribution about the battery, movement of Li+ ions about the battery and between the cathode(s) and anode(s), or both relative to traditional configurations. By way of the above-described features, presently disclosed embodiments are configured to improve battery performance, reduce or negate shorting, or both relative to traditional configurations. These and other aspects of the present disclosure are described in greater detail below with reference to the drawings.

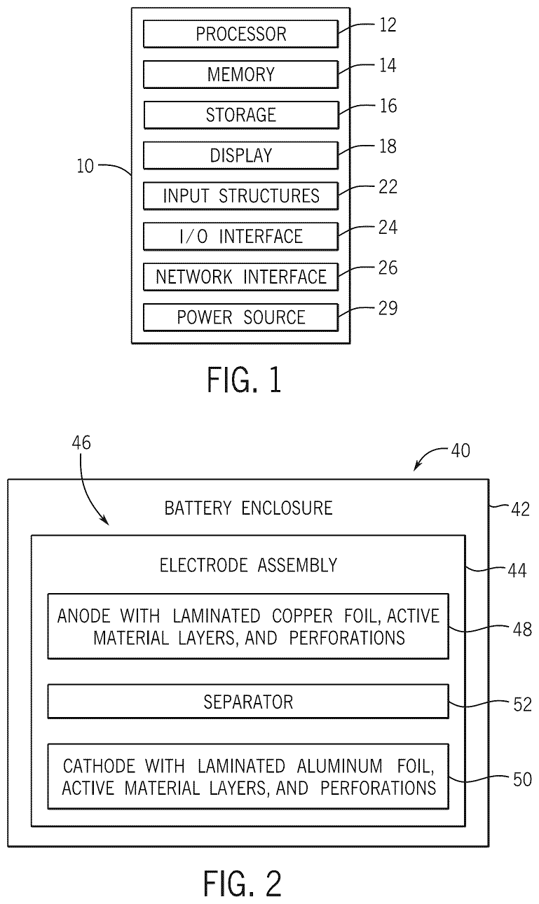

Continuing now with the drawings, FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, and other similar devices. In additional or alternative embodiments, the electronic device 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH network, a local area network (LAN) or wireless local area network (WLAN), such as a network employing one of the IEEE 802.11x family of protocols (e.g., WI-FI), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, Long Term Evolution (LTE) cellular network, Long Term Evolution License Assisted Access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX), mobile broadband Wireless networks (mobile WIMAX), asynchronous digital subscriber lines (e.g., ADSL, VDSL), digital video broadcasting-terrestrial (DVB-T) network and its extension DVB Handheld (DVB-H) network, ultra-wideband (UWB) network, alternating current (AC) power lines, and so forth.

The power source 29 of the electronic device 10 may include any suitable source of power, such as a rechargeable battery (e.g., lithium-ion battery) and/or an alternating current (AC) power converter. In accordance with the present disclosure, the battery of the power source 29 may include at least one electrode with a layered structure having a laminated foil (e.g., current collector) and active material layers on opposing sides of the laminated foil. The laminated foil may include, for example, a polymer substrate and metal foil layers on opposing sides of the polymer substrate. Perforations may be disposed through the layered structure (e.g., through both of the active material layers, both of the metal layers of the laminated foil, and the polymer substrate of the laminated foil) to improve electrolyte distribution through the battery, movement of Li+ ions about the battery, or both. The laminated foil may block, negate, or reduce metal burring (or effects thereof) that otherwise may be caused by a process that generates the perforations. These and other aspects of the present disclosure are described in greater detail below with reference to FIGS. 2-9.

FIG. 2 is a block diagram of an embodiment of a battery 40 (e.g., lithium-ion battery) configured to power a load, such as the electronic device 10 of FIG. 1. In the illustrated embodiment, the battery 40 includes a battery enclosure 42 and an electrode assembly 44 disposed in an interior 46 of the battery enclosure 42. The electrode assembly 44 includes an anode 48, a cathode 50, and a separator 52 between the anode 48 and the cathode 50. For brevity, only one instance of the anode 48, only one instance of the cathode 50, and only one instance of the separator 52 is shown in FIG. 2. However, it should be understood that the battery 40 may include multiple instances of the anode 48 and multiple instances of the cathode 50 arranged in an alternating configuration. Further, the battery 40 may include one or more instances of the separator 52 that operates to separate adjacent instances of the anode 48 and the cathode 50.

The anode 48 may include a laminated foil, such as a laminated copper foil (e.g., a copper laminate layer), active material layers on opposing sides of the laminated foil, and perforations. The laminated foil may include, for example, a polymer substrate (e.g., an anode polymer substrate) and metal layers (e.g., copper layers, copper laminate layers) on opposing sides of the polymer substrate. The active material layers of the anode 48 may include, for example, carbon-based materials, such as graphite and/or silicon. The perforations may extend through the laminated foil (e.g., the polymer substrate and the metal layers) and the active material layers on opposing sides of the laminated foil. Sizes of the perforations, described in greater detail with respect to later drawings, may be substantially smaller than pores (e.g., micropores) in the separator 52. For example, a diameter and/or cross-sectional area of each perforation may be substantially smaller than a diameter and/or cross-sectional area of each pore (e.g., micropore) in the separator 52.

The cathode 50 may include a laminated foil, such as a laminated aluminum foil (e.g., an aluminum laminate layer), active material layers on opposing sides of the laminated foil, and perforations. The laminated foil may include, for example, a polymer substrate (e.g., cathode polymer substrate) and metal layers (e.g., aluminum laminate layers) on opposing sides of the polymer substrate. The active material layers of the cathode may include, for example, metal oxides, such as lithium cobalt oxide, lithium manganese oxide, lithium iron phosphate, or lithium nickel manganese cobalt oxide. The perforations may extend through the laminated foil (e.g., the polymer substrate and the metal layers) and the active material layers on opposing sides of the laminated foil. Sizes of the perforations, described in greater detail with respect to later drawings, may be substantially smaller than pores (e.g., micropores) in the separator 52. For example, a diameter and/or cross-sectional area of each perforation may be substantially smaller than a diameter and/or cross-sectional area of each pore (e.g., micropore) in the separator 52.

In general, the polymer substrates for the anode 48 and the cathode 50 may reduce metal burring (or effects thereof) that otherwise may be caused by a process configured to generate the perforations described above. Additionally or alternatively, the perforations may improve electrolyte distribution about the interior 46 of the enclosure 42, movement of Li+ ions about the interior 46 of the enclosure 42 and between the anode(s) 48 and the cathode(s) 50, or both. Aspects of the perforations (e.g., sizes, shapes, etc.) are described in detail below with reference to later drawings.

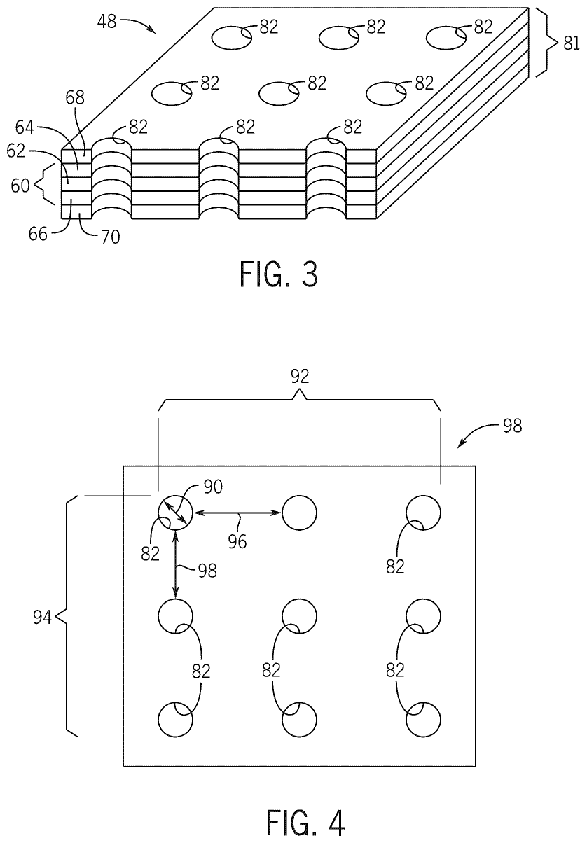

FIG. 3 is a perspective cut-away view of an embodiment of an electrode that may be employed in the battery 40 of FIG. 2, including perforations through a layered structure of the electrode. For clarity, the electrode in FIG. 3 is described in the context of the anode 48 illustrated in FIG. 2 and described above. However, it should be understood that a similar layered structure, but with different material compositions among other possible distinctions, may also be used for the cathode 50.

In the illustrated embodiment, the anode 48 includes a laminated foil 60. The laminated foil 60 includes a polymer substrate 62, a first metal layer 64 on a first side of the polymer substrate 62, and a second metal layer 66 on a second side of the polymer substrate 62 opposing the first side. The first metal layer 64 and the second metal layer 66 may include aluminum in certain embodiments. The first metal layer 64 and the second metal layer 66 may be laminated on the polymer substrate 62 (e.g., via a sputtering process). The anode 48 also includes a first active material layer 68 and a second active material layer 70 on opposing sides of the laminated foil 60. For example, laminated foil 60 may be sandwiched by the first active material layer 68 and the second active material layer 70. The first active material layer 68 and the second active material layer 70 may include, for example, carbon-based materials, such as graphite and/or silicon. The first active material layer 68, the first metal layer 64, the polymer substrate 62, the second metal layer 66, and the second active material layer 70 may be referred to as a layered structure 81 of the anode 48.

Perforations 82 may be disposed through the anode 48, as shown. The perforations 82 may extend through the first active material layer 68, the first metal layer 64, the polymer substrate 62, the second metal layer 66, and the second active material layer 70. As shown, the perforations 82 may include a cylindrical shape, although other shapes (e.g., a frustoconical shape) are also possible. Sizes, spacing, and other aspects of the perforations 82 may vary depending on the embodiment. As an example, FIG. 4 is a top view of an embodiment of an electrode (e.g., the anode 48 of FIG. 3) that may be employed in the battery 40 of FIG. 2. A diameter 90 of each perforation 82 may be between 50 micrometers and 500 micrometers, 100 micrometers and 400 micrometers, 200 micrometers and 300 micrometers, or 225 micrometers and 275 micrometers. As shown, the perforations 82 may be arranged in a grid pattern with rows 92 and columns 94 in certain embodiments, although patterns may vary in other embodiments. A first spacing 96 (e.g., first distance) between adjacent perforations 82 in each row 92 of FIG. 4 may be between 100 and 10000 micrometers, 1000 and 9000 micrometers, 2000 and 8000 micrometers, or 3000 and 7000 micrometers. A second spacing 98 (e.g., second distance) between adjacent perforations 82 in each column 94 of FIG. 4 may be between 100 and 10000 micrometers, 1000 and 9000 micrometers, 2000 and 8000 micrometers, or 3000 and 7000 micrometer. In some embodiments, the first spacing 96 is substantially equal to the second spacing 98, while in other embodiments, the first spacing 96 is different than the second spacing 98 (e.g., the first spacing 96 is larger than the second spacing 98, or the second spacing 98 is larger than the first spacing 96). In some embodiments, the perforations 82 may remove approximately 0.5% to 2% of the first active material layer 68 and/or the second active material layer 70. As previously described, the cathode 50 in FIG. 2 may include similar features as the anode 48 in FIGS. 3 and 4 and described above, except that the cathode 50 may include different material compositions.

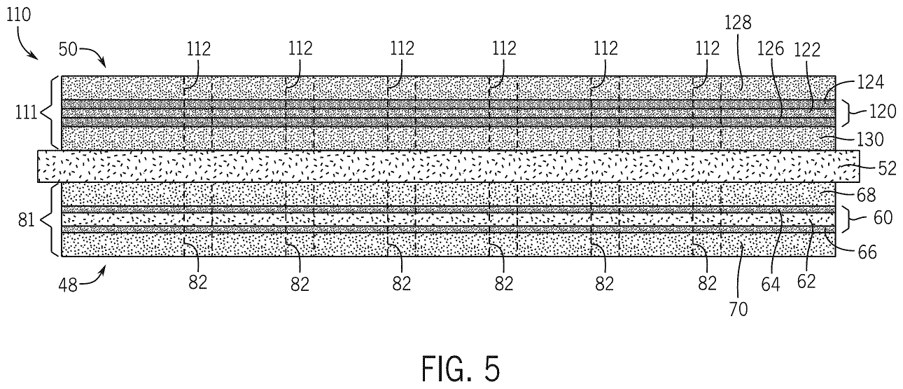

FIG. 5 is a cross-sectional side view of an embodiment of an electrode assembly 110 that may be employed in the battery 40 of FIG. 2, including the anode 48 with the layered structure 81 and the perforations 82 therethrough, the cathode 50 with a layered structure 111 and perforations 112 therethrough, and the separator 52 between the anode 48 and the cathode 50. The layered structure 111 of the cathode 50 includes a laminated foil 120 having a polymer substrate 122, a first metal layer 124 on a first side of the polymer substrate 122, and a second metal layer 126 on a second side of the polymer substrate 122 opposing the first side. The first metal layer 124 and the second metal layer 126 may include copper in certain embodiments. The first metal layer 124 and the second metal layer 126 may be laminated on the polymer substrate 122 (e.g., via a sputtering process). The cathode 50 also includes a first active material layer 128 and a second active material layer 130 on opposing sides of the laminated foil 120. For example, laminated foil 120 may be sandwiched by the first active material layer 128 and the second active material layer 130. The first active material layer 128 and the second active material layer 130 may include, for example, metal oxides, such as lithium cobalt oxide, lithium manganese oxide, lithium iron phosphate, or lithium nickel manganese cobalt oxide. The first active material layer 128, the first metal layer 124, the polymer substrate 122, the second metal layer 126, and the second active material layer 130 may be referred to as a layered structure 111 of the cathode 50.

In some embodiments, the polymer substrate 62 of the anode 48 includes the same or similar material composition as the polymer substrate 122 of the cathode 50, while in other embodiments, material compositions differ between the polymer substrate 62 and the polymer substrate 122. As previously described, in general, the polymer substrates 62, 122 in the laminated foils 60, 120 are configured to reduce or negate metal burring (or effects thereof) associated with perforation techniques configured to generate the perforations 82, 112 in the anode 48 and the cathode 50, respectively, relative to traditional configurations. Further, the perforations 82, 112 are configured to improve electrolyte distribution and/or movement of Li+ ions between the anode 48 and the cathode 50 relative to traditional configurations.

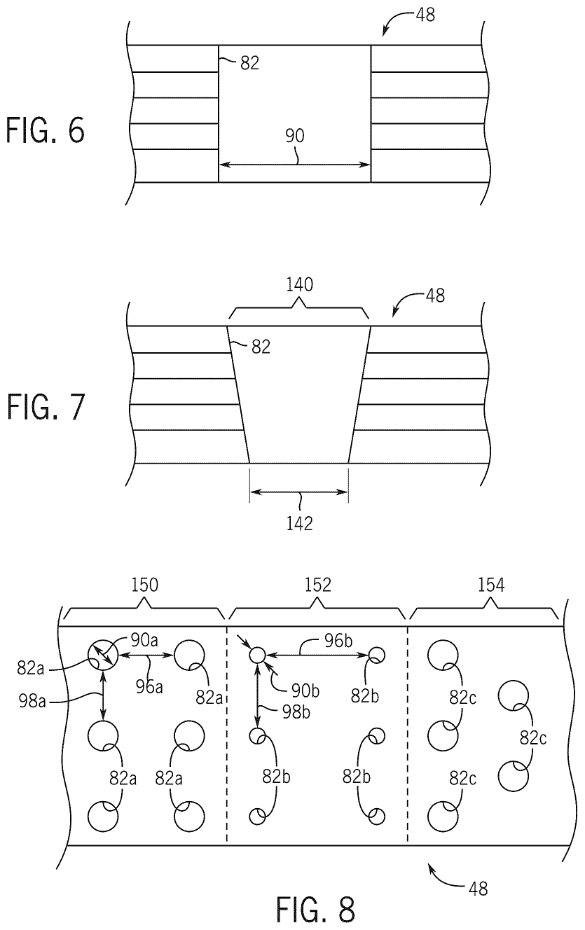

As previously described, the perforations 82, 112 may include a cylindrical shape, a frustoconical shape, or some other shape. For example, FIGS. 6 and 7 illustrate shapes of the perforations 82 in the anode 48. It should be understood that the same or similar shapes may also be used for the perforations 112 of the cathode 50. In FIG. 6, the perforation 82 includes a cylindrical shape, while in FIG. 7, the perforation 82 includes a frustoconical shape. In FIG. 6, the diameter 90 (e.g., cross-sectional diameter) of the perforation 82 is substantially constant, and may be between 50 micrometers and 500 micrometers, 100 micrometers and 400 micrometers, 200 micrometers and 300 micrometers, or 225 micrometers and 275 micrometers. In FIG. 7, the perforation 82 includes a variable diameter, including a maximum diameter 140 (e.g., a maximum cross-sectional diameter) and a minimum diameter 142 (e.g., a minimum cross-sectional diameter). The maximum diameter 140 may be between 50 micrometers and 500 micrometers, 100 micrometers and 400 micrometers, 200 micrometers and 300 micrometers, or 225 micrometers and 275 micrometers. The minimum diameter 142 may be between 25 micrometers and 475 micrometers, 75 micrometers and 375 micrometers, 175 micrometers and 275 micrometers, or 200 micrometers and 250 micrometers. In certain embodiments, the maximum diameter 140 may be approximately 110% to 200% of the minimum diameter 142, 120% to 175% of the minimum diameter 142, or 130% to 150% of the minimum diameter 142.

FIG. 8 is a top view of an embodiment of an electrode that may be employed in the battery 40 of FIG. 2, including non-uniform perforations through a layered structure of the electrode. In some embodiments, such as the embodiment illustrated in FIG. 4, the perforations 82 may be uniform in size, shape, and/or pattern, while in other embodiments, such as the embodiment illustrated in FIG. 8, non-uniform perforations may be employed. For example, relatively large perforations and/or relatively high perforation density may be selectively located in certain electrode areas or regions that are prone to electrolyte and/or Li+ ion blockages, thereby better promoting electrolyte distribution and movement of Li+ ions in said electrode areas or regions, and relatively small perforations and/or relatively low perforation density may be selective located in certain other electrode areas or regions that are not prone to electrolyte and/or Li+ ion blockages, thereby reducing an effect on battery volumetric energy density. Other differential perforation characteristics may also be employed for the same or similar reasons, such as perforation shape and/or pattern, as described in greater detail below with respect to FIG. 8.

For clarity, the electrode in FIG. 8 is described in the context of the anode 48. However, it should be understood that the cathode 50 may include the same or similar features, except that the cathode 50 may include different material compositions. In the illustrated embodiment, the anode 48 includes a first region 150 (e.g., a first segment), a second region 152 (e.g., a second segment), and a third region 154 (e.g., a third segment). Perforations 82a in the first region 150 differ in size, shape, and/or spacing from perforations 82b in the second region 152 and perforations 82c in the third region 154, and the perforations 82b in the second region 152 differ in size, shape, and/or spacing from the perforations 82c in the third region 154. For example, diameters 90a of the perforations 82a in the first region 150 differ from diameters 90b of the perforations 82b in the second region 152. Additionally or alternatively, the spacings 96a, 98a between adjacent perforations 82a in the first region 150 differ from spacings 96b, 98b between adjacent perforations 82b in the second region 152. Additionally or alternatively, the perforations 82c in the third region 154 include a different pattern than the perforations 82a in the first region 150 and the perforations 82b in the second region 152. For example, while the perforations 82a in the first region 150 and the perforations 82b in the second region 152 from grid patterns with rows and columns, the perforations 82c in the third region 154 are staggered (e.g., in a zig-zag pattern). It should be noted that other perforation variations are also possible. For example, perforation size, shape, pattern, and/or density may be functionally graded along the electrode.

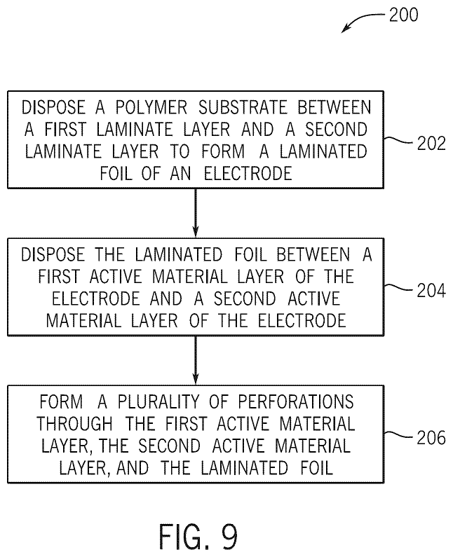

FIG. 9 is a process flow diagram illustrating an embodiment of a method 200 of manufacturing an electrode that may be employed in the battery 40 of FIG. 2, where the electrode includes a layered structure and perforations therethrough. The electrode may include, for example, an anode or a cathode. In the illustrated embodiment, the method 200 includes disposing (block 202) a polymer substrate between a first laminate layer (e.g., a first metal layer) and a second laminate layer (e.g., a second metal layer) to form a laminated foil of the electrode. For example, if the electrode is an anode, the first and second laminate layers (e.g., the first and second metal layers) may include copper, and if the electrode is a cathode, the first and second laminate layers (e.g., the first and second metal layers) may include aluminum. In some embodiments, the first laminate layer (e.g., the first metal layer) is sputtered onto a first side of the polymer substrate and the second laminate layer (e.g., the second metal layer) is sputtered onto a second side of the polymer substrate opposing the first side.

The method 200 also includes disposing (block 204) the laminated foil between a first active material layer of the electrode and a second active material layer of the electrode. For example, if the electrode is an anode, the first and second active material layers may include carbon-based materials, such as graphite and/or silicon, and if the electrode is a cathode, the first and second active material layers may include metal oxides, such as lithium cobalt oxide, lithium manganese oxide, lithium iron phosphate, or lithium nickel manganese cobalt oxide.

The method 200 also includes forming (block 206) a plurality of perforations through the first active material layer, the second active material layer, and the laminated foil (e.g., the first laminate layer, the polymer substrate, and the second laminate layer). The plurality of perforations through the electrode may be formed by a mechanical drilling process (e.g., mechanical perforation technique), a laser drilling process (e.g., laser perforation technique), a combination thereof, or some other suitable technique that reduces metal burring or effects thereof in accordance with the present disclosure.

Presently disclosed embodiments include an electrode with a layered structure and perforations through the layered structure that improve electrolyte distribution, movement of Li+ ions about, and/or battery performance over traditional configurations. Additionally or alternatively, the layered structure includes a laminated foil (e.g., a polymer substrate with metal layers on opposing sides of the polymer substrate) that reduces or negates metal burring (or effects thereof) relative to traditional configurations.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. An electrode assembly comprising:
an electrode comprising a laminated foil disposed between a first active material layer and a second active material layer, wherein the laminated foil comprises a polymer substrate disposed between a first laminate layer and a second laminate layer; and
a plurality of perforations extending through the first active material layer, the second active material layer, and the laminated foil.

2. The electrode assembly of claim 1, comprising:
an additional electrode comprising an additional laminated foil disposed between an additional first active material layer and an additional second active material layer, wherein the additional laminated foil comprises an additional polymer substrate disposed between an additional first laminate layer and an additional second laminate layer; and
an additional plurality of perforations extending through the additional first active material layer, the additional second active material layer, and the additional laminated foil.

3. The electrode assembly of claim 2, comprising a separator disposed between the electrode and the additional electrode.

4. The electrode assembly of claim 3, wherein the separator comprises a plurality of micropores, and each micropore of the plurality of micropores comprises a first cross-sectional area that is smaller than:
a second cross-sectional area of each perforation of the plurality of perforations; and
a third cross-sectional area of each additional perforation of the additional plurality of perforations.

5. The electrode assembly of claim 2, wherein:
the electrode comprises a cathode, the first laminate layer comprises a first aluminum laminate layer, and the second laminate layer comprises a second aluminum laminate layer; and
the additional electrode comprises an anode, the additional first laminate layer comprises a first copper laminate layer, and the additional second laminate layer comprises a second copper laminate layer.

6. The electrode assembly of claim 1, wherein a perforation of the plurality of perforations comprises a frustoconical shape.

7. The electrode assembly of claim 1, wherein a perforation of the plurality of perforations comprises a cylindrical shape.

8. The electrode assembly of claim 1, wherein a perforation of the plurality of perforations comprises a cross-sectional diameter of 50 to 500 micrometers.

9. The electrode assembly of claim 1, wherein the plurality of perforations comprises a first perforation and a second perforation separated by a distance between 100 micrometers and 10000 micrometers.

10. The electrode assembly of claim 1, wherein the laminated foil is configured to reduce metal burring or effects thereof associated with a perforation technique configured to generate the plurality of perforations.

11. A battery comprising:
an enclosure; and
an electrode assembly disposed in the enclosure, wherein the electrode assembly comprises:
a cathode comprising a laminated aluminum foil disposed between a first cathode active material layer and a second cathode active material layer;
a first plurality of perforations extending through the first cathode active material layer, the second cathode active material layer, and the laminated aluminum foil;
an anode comprising a laminated copper foil disposed between a first anode active material layer and a second anode active material layer;
a second plurality of perforations extending through the first anode active material layer, the second anode active material layer, and the laminated copper foil; and
a separator disposed between the cathode and the anode.

12. The battery of claim 11, wherein:
the laminated aluminum foil comprises a cathode polymer substrate disposed between a first aluminum laminate layer and a second aluminum laminate layer; and
the laminated copper foil comprises an anode polymer substrate disposed between a first copper laminate layer and a second copper laminate layer.

13. The battery of claim 11, wherein a perforation of the first plurality of perforations comprises a frustoconical shape or a cylindrical shape.

14. The battery of claim 11, wherein the electrode assembly comprises a jelly roll configuration or a stacked configuration.

15. The battery of claim 11, wherein a perforation of the first plurality of perforations comprises a cross-sectional diameter of 50 to 500 micrometers.

16. The battery of claim 11, wherein the first plurality of perforations comprises a first perforation and a second perforation separated by a distance between 100 micrometers and 10000 micrometers.

17. A method comprising:
disposing a polymer substrate between a first laminate layer and a second laminate layer to form a laminated foil of an electrode;
disposing the laminated foil between a first active material layer of the electrode and a second active material layer of the electrode; and
forming a plurality of perforations through the first active material layer, the second active material layer, and the laminated foil.

18. The method of claim 17, comprising forming the plurality of perforations through the first active material layer, the second active material layer, and the laminated foil via a mechanical perforation technique or a laser perforation technique, wherein the laminated foil is configured to reduce or negate metal burring or effects thereof associated with the mechanical perforation technique or the laser perforation technique.

19. The method of claim 17, comprising disposing the polymer substrate between the first laminate layer and the second laminate layer by sputtering the first laminate layer and the second laminate layer on opposing sides of the polymer substrate.

20. The method of claim 17, comprising:
disposing an additional polymer substrate between an additional first laminate layer and an additional second laminate layer to form an additional laminated foil of an additional electrode;
disposing the additional laminated foil between an additional first active material layer of the additional electrode and an additional second active material layer of the additional electrode;
forming an additional plurality of perforations through the additional first active material layer, the additional second active material layer, and the additional laminated foil; and disposing a separator between the electrode and the additional electrode.
